(19) United States
(12) Patent Application Publication
(10) Pub. No.: US 2016/0224118 A1
(43) Pub. Date: Aug. 4, 2016

(54) HELMET-USED TOUCHLESS SENSING AND GESTURE RECOGNITION STRUCTURE AND HELMET THEREOF

(71) Applicant: KDH-DESIGN SERVICE INC., Taipei City (TW)

(72) Inventor: Younger Liang, Taipei City (TW)

(21) Appl. No.: 14/612,219

(22) Filed: Feb. 2, 2015

(51) Int. Cl. G06F 3/01; G02B 27/01

(52) U.S. Cl. CPC G06F 3/017; G02B 27/017; G06F 3/011

(57) ABSTRACT

A helmet-used gesture recognition structure includes a transmission unit, multiple receiving units and a processing unit connected to the transmission unit and the receiving units. The transmission unit serves to transmit at least one signal. The receiving units serve to receive reflection signals reflected from an input object contacting the signal transmission unit. According to the sequence in which the receiving units respectively receive the reflection signals, the processing unit judges and identifies the position and/or motion of the input object and generates a gesture signal for interacting with a user interface of the helmet.

### BACKGROUND OF THE INVENTION

1. Field of the Invention

The present invention relates generally to a helmet, and more particularly to a helmet with gesture recognition structure.

2. Description of the Related Art

U.S. Pat. No. 5,646,784 discloses a conventional helmet display system. The helmet display system has a visor disposed on the helmet. A holographic combiner is formed on the visor. Two image projectors are disposed in the helmet for projecting images onto the holographic combiner on the visor. The holographic combiner serves to reflect the projected images to the eyes of a wearer. Also, the eyes of the wearer can see outer side through the visor.

Skully Company provides another conventional helmet Skully AR-1. A head-up display (HUD) is added into the helmet. The HUD is inbuilt with GPS navigation system and back lens. A wearer not only can see the outer environment in front of his body through the visor as a common helmet, but also can see the environment behind his body through the HUD. In addition, the wearer can see the GPS navigation information through the HUD.

There is a trend to add display function to the helmet. However, no interaction between the helmet wearer and the displayed information is disclosed, especially instinctive interaction.

### SUMMARY OF THE INVENTION

It is therefore a primary object of the present invention to provide a gesture recognition structure applied to helmet. The gesture recognition structure is able to judge and identify different gestures and generate different gesture signals for interacting with a user interface of the helmet.

It is a further object of the present invention to provide a helmet having a human-machine interface unit and a gesture recognition structure connected to the human-machine interface unit.

It is still a further object of the present invention to provide a motorcycle-used or automobile-used helmet. The helmet is able to produce user interface information. A part of the body of the helmet wearer can interact with the user interface information in a touchless and suspending/floating manner.

It is still a further object of the present invention to provide a helmet, which is able to identify a wearer's gestures without being affected by the change of external environment.

To achieve the above and other objects, the present invention provides a helmet-used gesture recognition structure. The helmet has a touchless user interface. The gesture recognition structure includes: a transmission unit for transmitting at least one signal; multiple receiving units for receiving reflection signals reflected from an input object contacting the signal; and a processing unit connected to the transmission unit and the receiving units. According to the sequence in which the receiving units respectively receive the reflection signals, the processing unit judges and identifies the position and/or motion of the input object and generates a gesture signal for interacting with the user interface.

In the above helmet-used gesture recognition structure, the signal is ultrasonic signal and the reflection signals are ultrasonic reflection signals.

In the above helmet-used gesture recognition structure, the transmission unit is an ultrasonic transmitter and the receiving units are ultrasonic receivers.

In the above helmet-used gesture recognition structure, the input object contacts the signal in different times to produce the reflection signals in sequence.

In the above helmet-used gesture recognition structure, the touchless user interface is a projected image containing multiple data.

In the above helmet-used gesture recognition structure, the input object is a part of a user's body.

In the above helmet-used gesture recognition structure, the receiving units are at least three receiving units. Two of the receiving units are positioned on the same level and left and right arranged, while the rest receiving unit is disposed on upper side or lower side of the two receiving units.

The present invention also provides a helmet including: a helmet body having a front side and a human-machine interface unit for producing a touchless user interface; a transmission unit disposed on a front side of the helmet body for transmitting at least one signal; a first receiving unit disposed on the front side of the helmet body for receiving a first reflection signal reflected from an input object contacting the signal; a second receiving unit disposed on the front side of the helmet body for receiving a second reflection signal reflected from the input object contacting the signal; a third receiving unit disposed on the front side of the helmet body for receiving a third reflection signal reflected from the input object contacting the signal; and a processing unit connected to the transmission unit and the first, second and third receiving units and the human-machine interface unit, whereby according to the sequence in which the first, second and third receiving units respectively receive the first, second and third reflection signals, the processing unit judges and identifies the position and/or motion of the input object and generates a gesture signal to the human-machine interface unit in accordance with the motion of the input object for interacting with the user interface.

In the above helmet, the second and third receiving units are positioned on the same level and left and right arranged and the first receiving unit is disposed on upper side or lower side of the second receiving unit or the third receiving unit.

In the above helmet, the signal is ultrasonic signal and the first, second and third reflection signals are ultrasonic reflection signals.

In the above helmet, the transmission unit is an ultrasonic transmitter and the receiving units are ultrasonic receivers.

In the above helmet, the input object contacts the signal in different times to produce the first, second and third reflection signals in sequence.

In the above helmet, the touchless user interface is a projected image containing multiple data.

In the above helmet, the human-machine interface unit is a projector.

In the above helmet, the helmet body has a visor disposed on the front side of the helmet body. The human-machine interface unit serves to project the user interface onto a predetermined position of the visor.

In the above helmet, the human-machine interface unit is head-up display. The head-up display has a lens assembly for showing the user interface.

In the above helmet, the input object is a part of a user's body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram showing the application of the gesture recognition structure of the present invention to a helmet;

FIG. 2 is a view showing the application of the gesture recognition structure of the present invention to a helmet;

FIG. 3 is a view showing the vision seen from the interior of the helmet through the visor to outer side;

FIG. 4 is a schematic diagram showing the arrangement positions of the receiving units of the present invention and showing that the receiving units receive the reflection signals;

FIG. 5 is a matrix diagram of the gesture judgment of the present invention;

FIG. 6 is a view showing another embodiment of the human-machine interface unit of the present invention;

FIG. 7 is a view showing another embodiment of the helmet of the present invention;

FIG. 8 is a schematic diagram according to FIG. 7, showing the arrangement positions of the receiving units of the present invention and showing that the receiving units receive the reflection signals;

FIG. 9 is a matrix diagram of the gesture judgment according to FIGS. 7 and 8;

FIG. 10 is a view showing the interaction between the input object and the user interface in a first aspect;

FIG. 11 is a view showing the interaction between the input object and the user interface in a second aspect; and

FIG. 12 is a view showing the interaction between the input object and the user interface in a third aspect.

### DETAILED DESCRIPTION OF THE PREFERRED EMBODIMENTS

The embodiments of the present invention will be described hereinafter with reference to the drawings, wherein the same components are denoted with the same reference numerals.

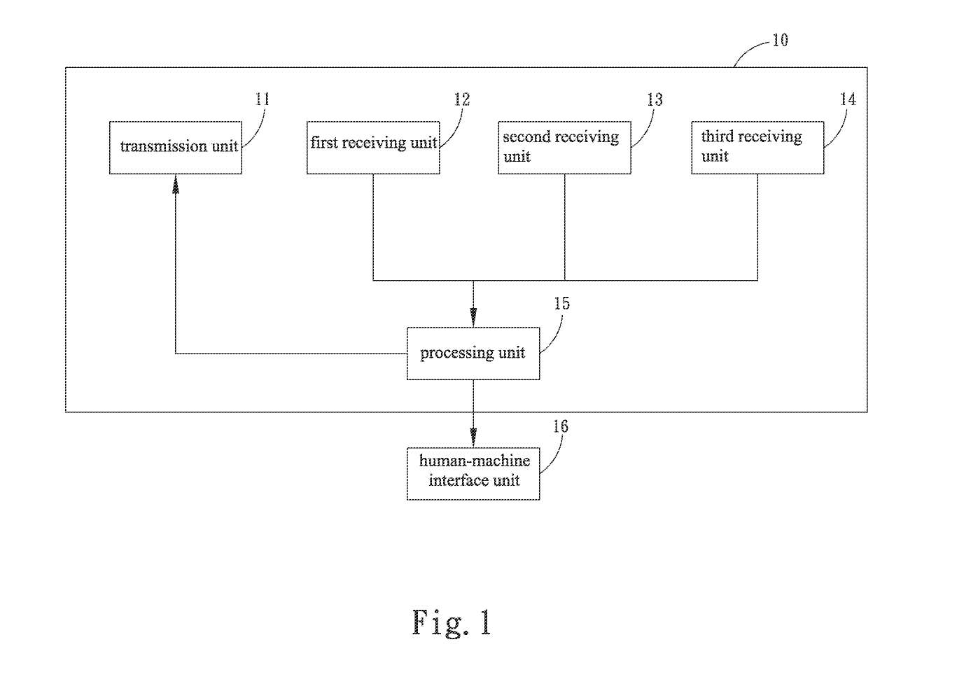

Please refer to FIG. 1, which is a block diagram showing the application of the gesture recognition structure of the present invention to a helmet. As shown in FIG. 1, the gesture recognition structure 10 of the present invention includes a transmission unit 11, multiple receiving units and a processing unit 15 connected to the transmission unit 11 and the receiving units. In a preferred embodiment, the transmission unit 11 is an ultrasonic transmitter for transmitting at least one signal. In a preferred embodiment, the signal is an ultrasonic signal. The receiving units serve to receive reflection signals. In this embodiment, the receiving units include a first receiving unit 12 for receiving a first reflection signal, a second receiving unit 13 for receiving a second reflection signal and a third receiving unit 14 for receiving a third reflection signal. In a preferred embodiment, the first to third receiving units 12˜14 are ultrasonic receivers. In a preferred embodiment, the first to third reflection signals are ultrasonic reflection signals. The processing unit 15 is further connected to a human-machine interface unit 16. According to the sequence in which the first to third receiving units 12˜14 receive the first to third reflection signals, the processing unit 15 judges or identifies the position and/or motion of an input object and generates a corresponding gesture signal to the human-machine interface unit 16.

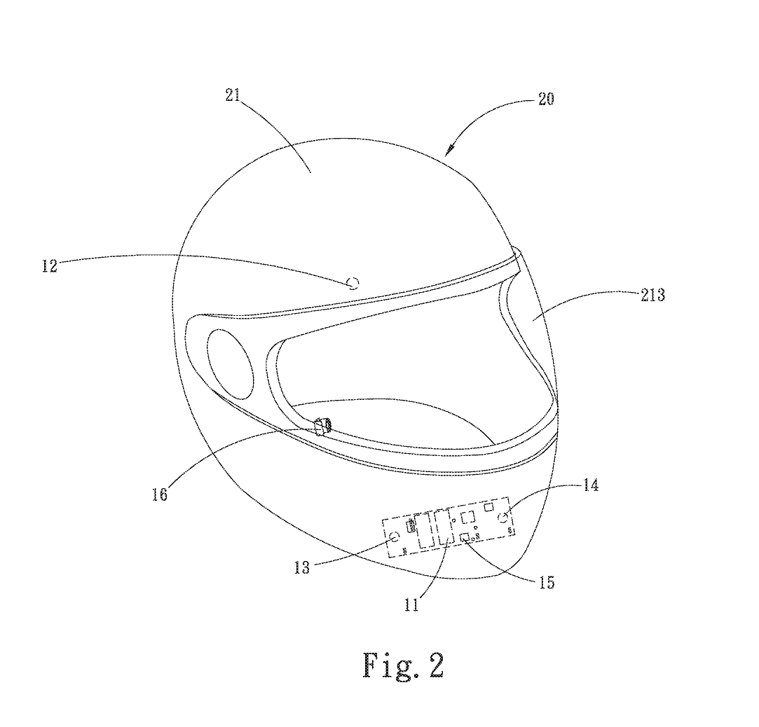

Please now refer to FIG. 2, which is a view showing the application of the gesture recognition structure of the present invention to a helmet. As shown in FIG. 2, the helmet 20 includes a helmet body 21 having a visor 213 disposed on front side of the helmet body 21. The human-machine interface unit 16 is disposed in the helmet body 21. The transmission unit 11, the first to third receiving units 12˜14 and the processing unit 15 are disposed on front side of the helmet body 21.

It should be especially noted that in this embodiment, the second and third receiving units 13, 14 are positioned on the same level and left and right arranged. The first receiving unit 12 is disposed on upper side or lower side of the second receiving unit 13 or the third receiving unit 14. FIG. 2 shows that the first receiving unit 12 is disposed on upper side of the visor 213 (such as the forehead section of the helmet 20). The second and third receiving units 13, 14 are disposed on lower side of the visor 213 (such as the chin bar of the helmet 20). The second receiving unit 13 is positioned on right side of the helmet body 21 for receiving the reflection signal of the front-side rightward region of the helmet body 21. The third receiving unit 14 is positioned on left side of the helmet body 21 for receiving the reflection signal of the front-side leftward region of the helmet body 21.

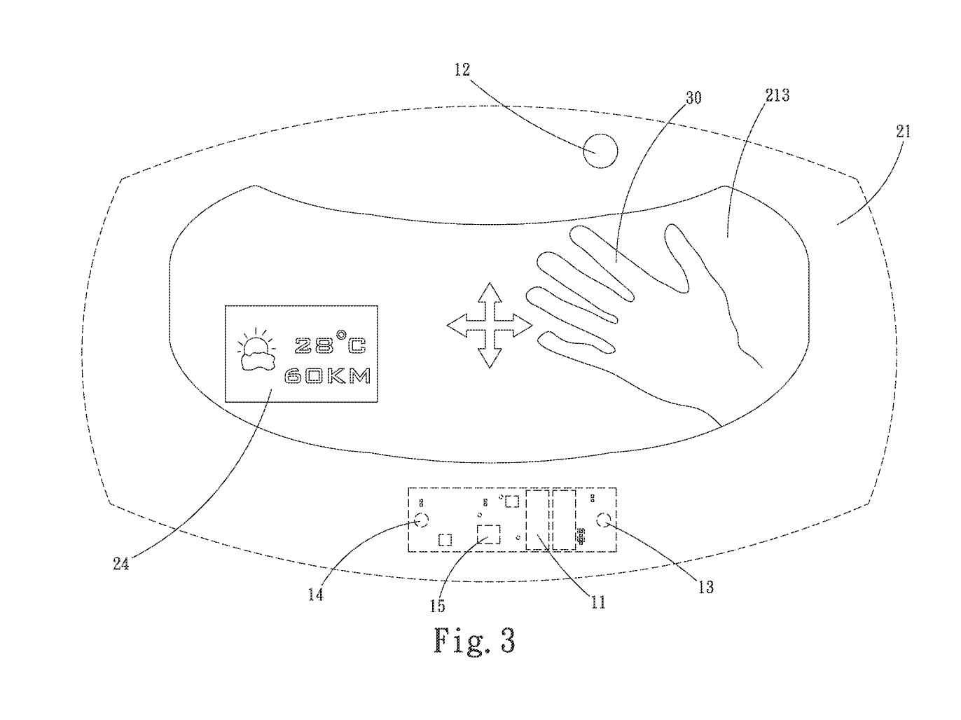

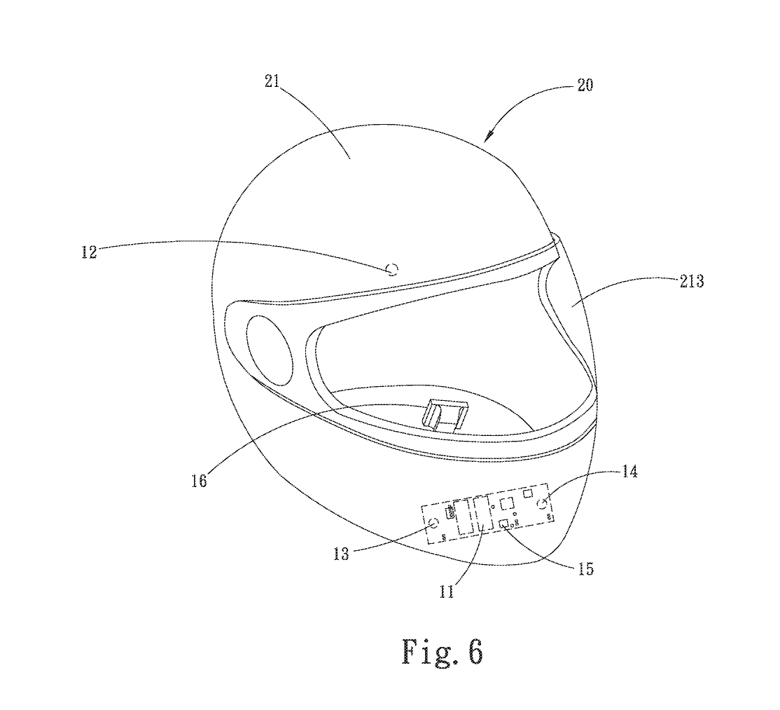

Please now refer to FIG. 3, which is a view showing the vision seen from the interior of the helmet 20 through the visor 213 to outer side. As shown in FIG. 3 as well as FIG. 2, the human-machine interface unit 16 serves to produce a touchless user interface 24. In a preferred embodiment, the human-machine interface unit 16 is a projector for projecting the user interface 24 onto a predetermined position on the visor 213. The predetermined position is preferably on the right lower side or left lower side of the vision of the helmet wearer. Alternatively, as shown in FIG. 6, the human-machine interface unit 16 can be a head-up display (HUD) for showing the user interface 24. Therefore, the human-machine interface unit 16 is preferably positioned on the right lower side or left lower side of the vision of the helmet wearer. The touchless user interface 24 is a projected image containing multiple data (such as weather, GPS, volume, music menu, program menu, user icon, etc.)

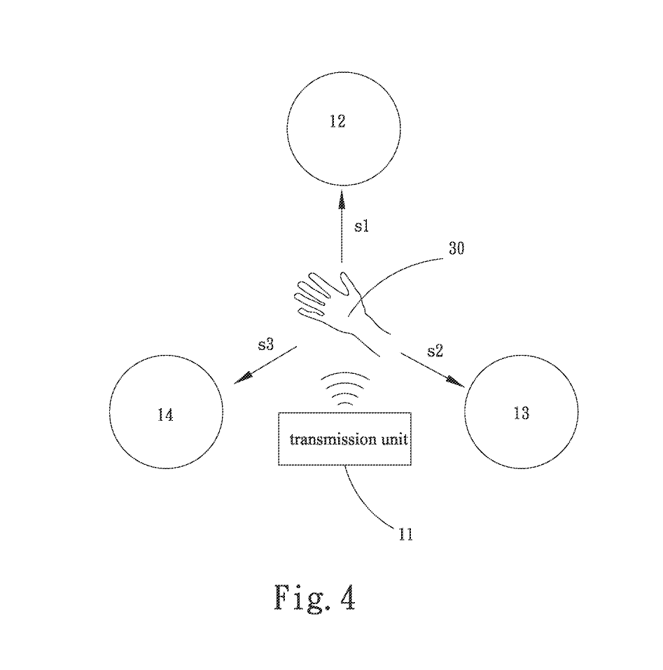

Please now refer to FIG. 4, which is a schematic diagram showing the arrangement positions of the receiving units and showing that the receiving units receive the reflection signals. As shown in FIG. 4 as well as FIGS. 2 and 3, according to the vision seen from the interior of the helmet 20 to outer side, an input object 30 is stopped or moved up and down and left and right within the distance and range of the transmission signal of the transmission unit 11 on the front side of the helmet body 21 of the helmet 20. The signal transmitted from the transmission unit 11 is contacted and reflected by the input object 30. When the input object 30 stops moving, the reflection signal is continuously received by the same receiving unit. When the input object 30 moves to contact the signal of the transmission unit 11, a time difference of the reflection signal is produced. Accordingly, the first to third receiving units 12˜14 respectively sequentially receive the first reflection signal (indicated by arrow s1), the second reflection signal (indicated by arrow s2) and the third reflection signal (indicated by arrow s3). The first receiving unit 12 is positioned on the upper side of the visor 213 to receive the first reflection signal s1. The second receiving unit 13 is positioned on the lower side of the visor 213 to receive the second reflection signal s2 from the right-side region of the helmet 20. The third receiving unit 14 is positioned on the lower side of the visor 213 to receive the third reflection signal s3 from the left-side region of the helmet 20. The input object 30 is a part of the user's body, such as the hand of the user.

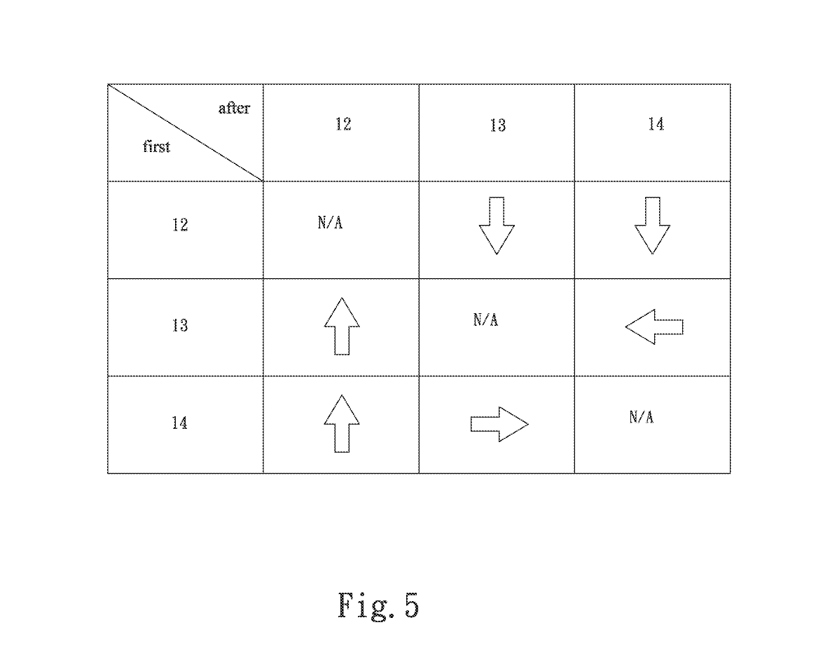

FIG. 5 is a matrix diagram of the gesture judgment of the present invention. As shown in FIG. 5 as well as FIGS. 1 to 4, according to the gesture judgment matrix of FIG. 5, the processing unit 15 generates gesture signal to the human-machine interface unit 16. The judgment steps of the processing unit 15 are as follows:

According to the time sequence in which the first receiving unit 12 receives the first reflection signal s1, the processing unit 15 judges that the input object 30 is positioned on an upper region.

According to that the first receiving unit 12 first receives the first reflection signal s1 and then the second receiving unit 13 receives the second reflection signal s2, the processing unit 15 generates a downward gesture signal.

According to that the first receiving unit 12 first receives the first reflection signal s1 and then the third receiving unit 14 receives the third reflection signal s3, the processing unit 15 generates a downward gesture signal.

According to that the second receiving unit 13 first receives the second reflection signal s2 and then the first receiving unit 12 receives the first reflection signal s1, the processing unit 15 generates an upward gesture signal.

According to the time sequence in which the second receiving unit 13 receives the second reflection signal s2, the processing unit 15 judges that the input object 30 is positioned on a right-side region.

According to that the second receiving unit 13 first receives the second reflection signal s2 and then the third receiving unit 14 receives the third reflection signal s3, the processing unit 15 generates a leftward gesture signal.

According to that the third receiving unit 14 first receives the third reflection signal s3 and then the first receiving unit 12 receives the first reflection signal s1, the processing unit 15 generates an upward gesture signal.

According to that the third receiving unit 14 first receives the third reflection signal s3 and then the second receiving unit 13 receives the second reflection signal s2, the processing unit 15 generates a rightward gesture signal.

According to the time sequence in which the third receiving unit 14 receives the third reflection signal s3, the processing unit 15 judges that the input object 30 is positioned on a left-side region.

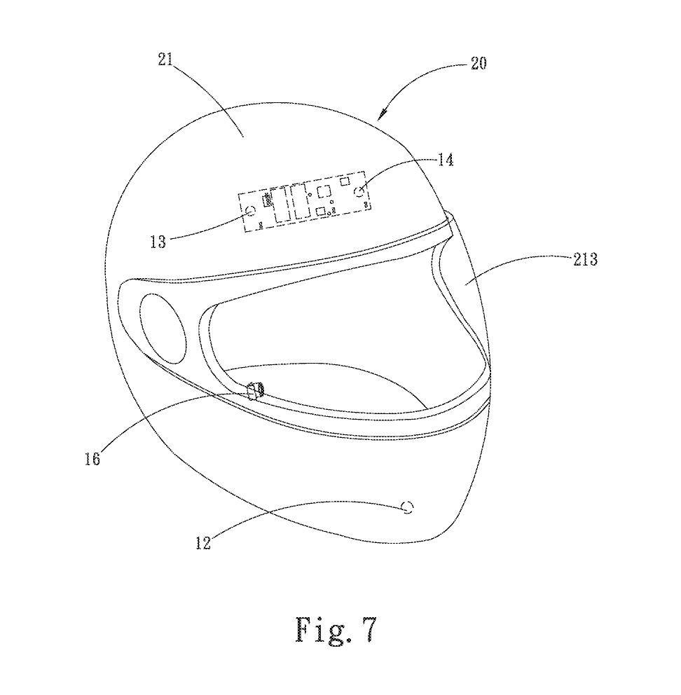

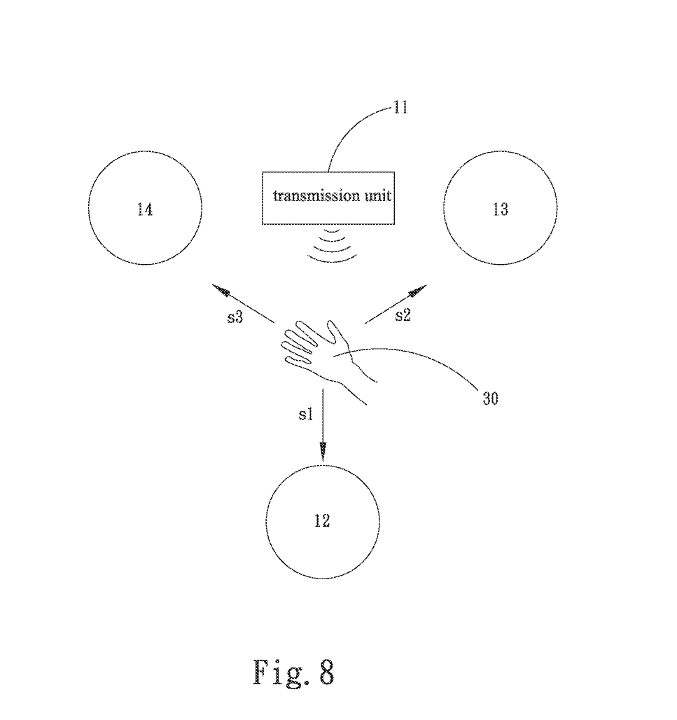

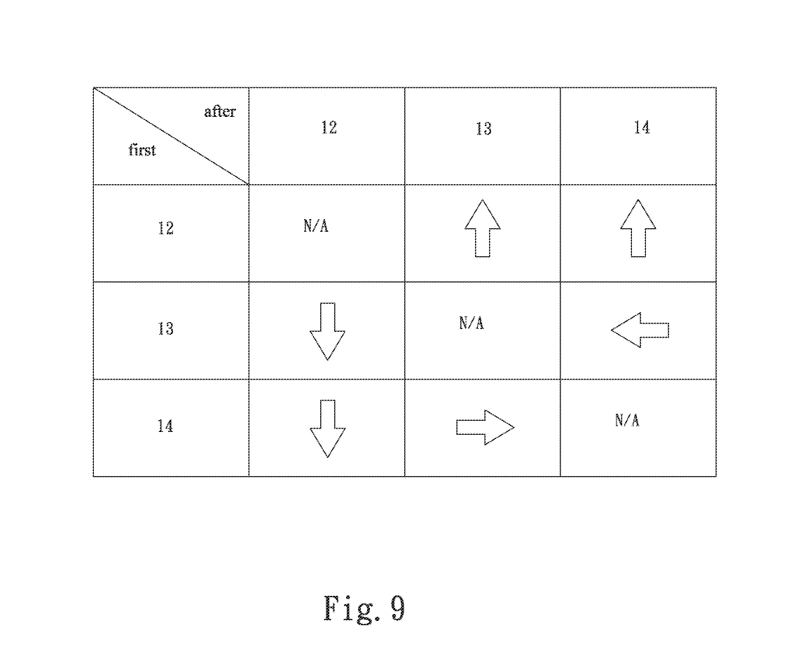

Please now refer to FIGS. 7, 8 and 9. FIG. 7 is a view showing another embodiment of the helmet of the present invention. FIG. 8 is a schematic diagram according to FIG. 7, showing the arrangement positions of the receiving units of the present invention and showing that the receiving units receive the reflection signals. FIG. 9 is a matrix diagram of the gesture judgment according to FIGS. 7 and 8. As shown in FIGS. 7 to 9 as well as FIG. 1, in another embodiment, the second and third receiving units 13, 14 are disposed on the upper side of the visor 213 (such as the forehead section of the helmet). The second receiving unit 13 is positioned on right side of the helmet body 21 for receiving the reflection signal of the front right-side region of the helmet body 21. The third receiving unit 14 is positioned on left side of the helmet body 21 for receiving the reflection signal of the front left-side region of the helmet body 21. The first receiving unit 12 is disposed on lower side of the visor 213 (such as the chin bar of the helmet).

FIG. 8 shows a vision seen from the interior of the helmet 20 to outer side. The signal transmitted from the transmission unit 11 is contacted and reflected by the input object 30. When the input object 30 moves to contact the signal of the transmission unit 11, a time difference of the reflection signal is produced. Accordingly, the first to third receiving units 12˜14 respectively sequentially receive the first reflection signal (indicated by arrow s1), the second reflection signal (indicated by arrow s2) and the third reflection signal (indicated by arrow s3). The first receiving unit 12 is positioned on the lower side of the visor 213 to receive the first reflection signal s1. The second receiving unit 13 is positioned on the upper side of the visor 213 to receive the second reflection signal s2 from the right-side region of the helmet 20. The third receiving unit 14 is positioned on the upper side of the visor 213 to receive the third reflection signal s3 from the left-side region of the helmet 20. The input object 30 is a part of the user's body, such as the hand of the user.

According to the gesture judgment matrix of FIG. 9, the processing unit 15 generates gesture signal to the human-machine interface unit 16. The judgment steps of the processing unit 15 are as follows:

According to the time sequence in which the first receiving unit 12 receives the first reflection signal s1, the processing unit 15 judges that the input object 30 is positioned on a lower region.

According to that the first receiving unit 12 first receives the first reflection signal s1 and then the second receiving unit 13 receives the second reflection signal s2, the processing unit 15 generates an upward gesture signal.

According to that the first receiving unit 12 first receives the first reflection signal s1 and then the third receiving unit 14 receives the third reflection signal s3, the processing unit 15 generates an upward gesture signal.

According to that the second receiving unit 13 first receives the second reflection signal s2 and then the first receiving unit 12 receives the first reflection signal s1, the processing unit 15 generates a downward gesture signal.

According to the time sequence in which the second receiving unit 13 receives the second reflection signal s2, the processing unit 15 judges that the input object 30 is positioned on a right-side region.

According to that the second receiving unit 13 first receives the second reflection signal s2 and then the third receiving unit 14 receives the third reflection signal s3, the processing unit 15 generates a leftward gesture signal.

According to that the third receiving unit 14 first receives the third reflection signal s3 and then the first receiving unit 12 receives the first reflection signal s1, the processing unit 15 generates a downward gesture signal.

According to that the third receiving unit 14 first receives the third reflection signal s3 and then the second receiving unit 13 receives the second reflection signal s2, the processing unit 15 generates a rightward gesture signal.

According to the time sequence in which the third receiving unit 14 receives the third reflection signal s3, the processing unit 15 judges that the input object 30 is positioned on a left-side region.

The interaction between the input object 30 and the user interface 24 will be described hereinafter by example.

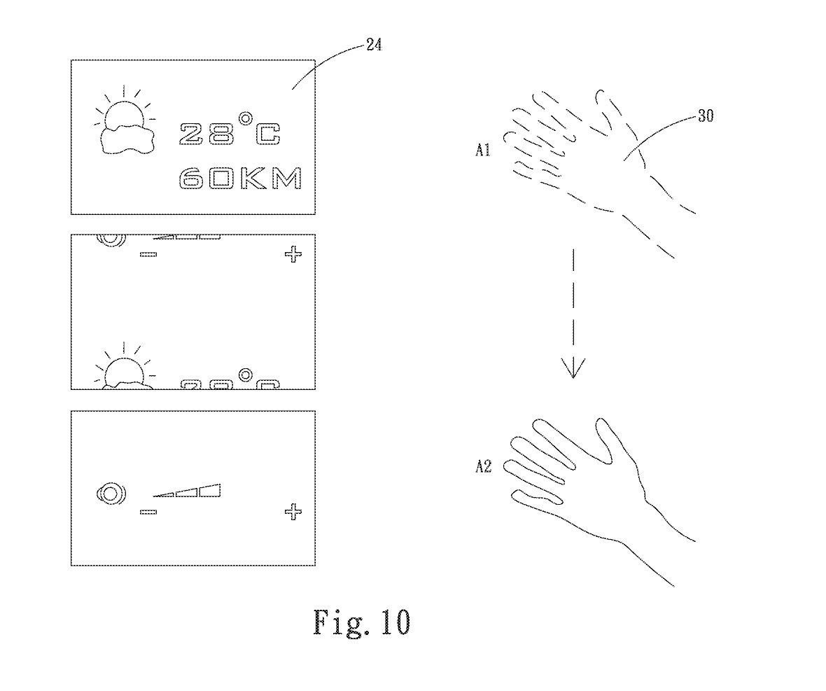

Please refer to FIG. 10, which is a view showing the interaction between the input object and the user interface in a first aspect. As shown in FIG. 10 as well as FIGS. 1 to 5, when the input object 30 (the hand of the wearer of the helmet 20) on the front side of the helmet 20 is downward moved from a first position A1 to a second position A2, the first receiving unit 12 first receives the first reflection signal s1 and then the second receiving unit 13 receives the second reflection signal s2 or the third receiving unit 14 receives the third reflection signal s3. At this time, the processing unit 15 outputs a downward gesture signal to the human-machine interface unit 16, whereby the user interface 24 projected on the visor 213 is downward moved from the first information (such as weather information) to the second information (such as volume information). Accordingly, when the input object 30 is moved in front of the helmet 20, the input object 30 can interact with the user interface 24 in a touchless and suspending/floating manner to downward turn the page of the information in the user interface 24.

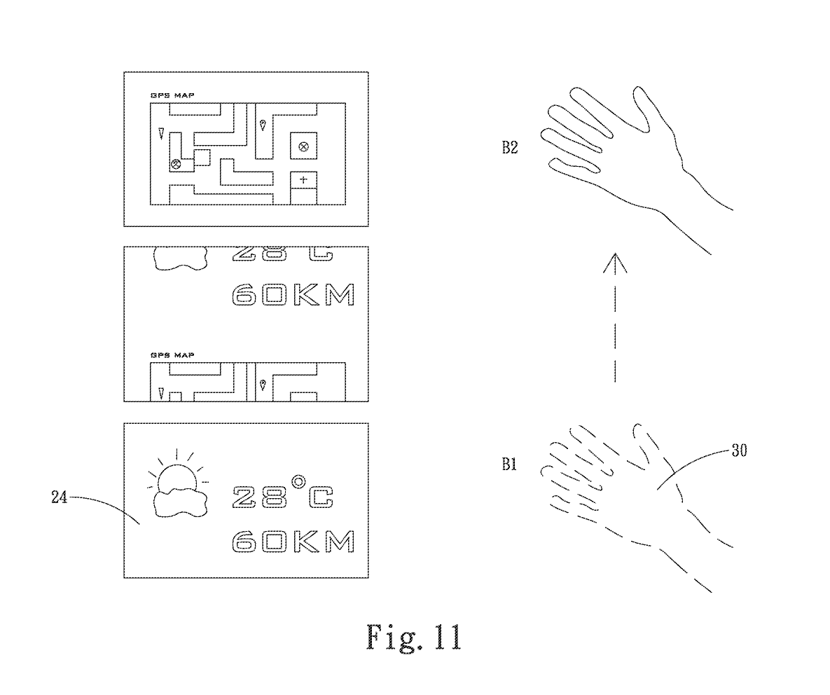

Please refer to FIG. 11, which is a view showing the interaction between the input object and the user interface in a second aspect. As shown in FIG. 11 as well as FIGS. 1 to 5, when the input object 30 (the hand of the wearer of the helmet 20) on the front side of the helmet 20 is upward moved from a first position B1 to a second position B2, the second receiving unit 13 first receives the second reflection signal s2 or the third receiving unit 14 first receives the third reflection signal s3 and then the first receiving unit 12 receives the first reflection signal s1. At this time, the processing unit 15 outputs an upward gesture signal to the human-machine interface unit 16, whereby the user interface 24 projected on the visor 213 is upward moved from the first information (such as weather information) to the second information (such as GPS navigation). Accordingly, when the input object 30 is moved in front of the helmet 20, the input object 30 can interact with the user interface 24 in a touchless and suspending/floating manner to upward turn the page of the information in the user interface 24.

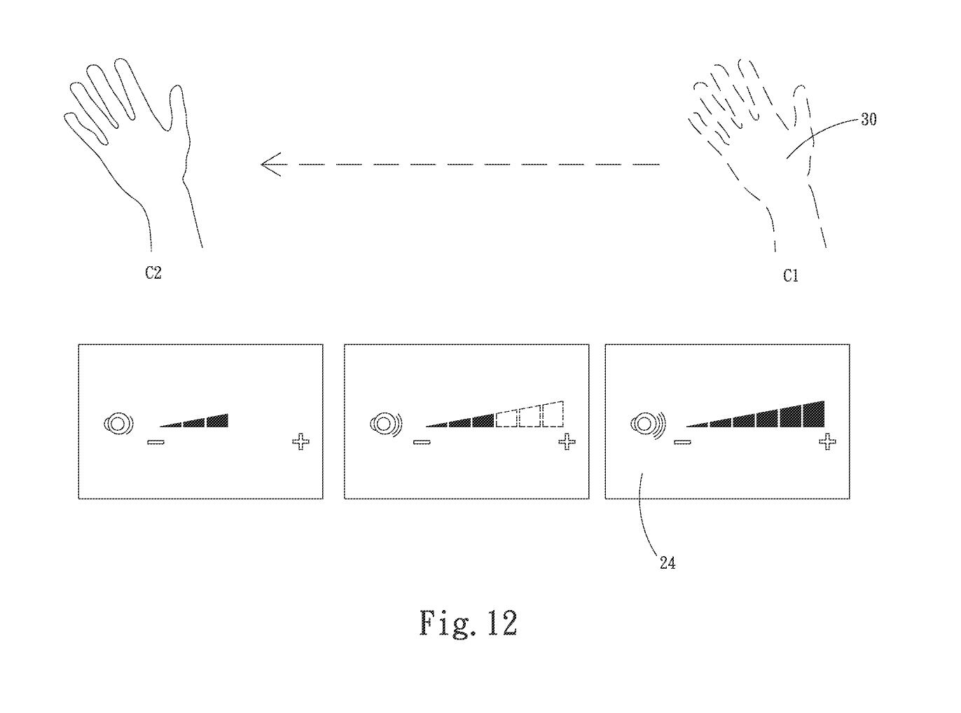

Please refer to FIG. 12, which is a view showing the interaction between the input object and the user interface in a third aspect. As shown in FIG. 12 as well as FIGS. 1 to 5, when the input object 30 (the hand of the wearer of the helmet 20) on the front side of the helmet 20 is leftward moved from a first position C1 to a second position C2, the second receiving unit 13 first receives the second reflection signal s2 and then the third receiving unit 14 receives the third reflection signal s3. At this time, the processing unit 15 outputs a leftward gesture signal to the human-machine interface unit 16, whereby the volume information of the user interface 24 projected on the visor 213 is adjusted and minified. Accordingly, when the input object 30 is moved in front of the helmet 20, the input object 30 can interact with the user interface 24 in a touchless and suspending/floating manner to adjust the volume.

In conclusion, by means of the gesture recognition structure of the present invention, the position or motion of the input object can be identified. Then, according to the motion of the input object, different gesture signals are generated to interact with the user interface. In this case, the hand of the helmet wearer can move in front of the helmet interact with the information of the user interface in a touchless and suspending/floating manner. Especially in advancing of a motorcycle, the helmet wearer can interact with the user interface without being affected by the change of external environment such as sunny day or rainy day or windy day.

The present invention has been described with the above embodiments thereof and it is understood that many changes and modifications in the above embodiments can be carried out without departing from the scope and the spirit of the invention that is intended to be limited only by the appended claims.

What is claimed is:

1. A helmet-used gesture sensing and recognition structure, the helmet having a touchless user interface, the gesture recognition structure comprising:
a transmission unit for transmitting at least one signal;
multiple receiving units for receiving reflection signals reflected from an input object contacting the signal; and
a processing unit connected to the transmission unit and the receiving units, whereby according to the sequence in which the receiving units respectively receive the reflection signals, the processing unit judges and identifies the position and/or motion of the input object and generates a gesture signal in accordance with the motion of the input object for interacting with the user interface.

2. The helmet-used gesture sensing and recognition structure as claimed in claim 1, wherein the signal is ultrasonic signal and the reflection signals are ultrasonic reflection signals.

3. The helmet-used gesture sensing and recognition structure as claimed in claim 2, wherein the transmission unit is an ultrasonic transmitter and the receiving units are ultrasonic receivers.

4. The helmet-used gesture sensing and recognition structure as claimed in claim 1, wherein the input object contacts the signal in different times, whereby the reflection signals have a time difference.

5. The helmet-used gesture sensing and recognition structure as claimed in claim 1, wherein the touchless user interface is a projected image containing multiple data.

6. The helmet-used gesture sensing and recognition structure as claimed in claim 1, wherein the input object is a part of a user's body.

7. The helmet-used gesture sensing and recognition structure as claimed in claim 1, wherein the receiving units are at least three receiving units, two of the receiving units being positioned on the same level and left and right arranged, the rest receiving unit being disposed on upper side or lower side of the two receiving units.

8. A helmet comprising:
a helmet body having a human-machine interface unit for producing a touchless user interface;
a transmission unit disposed on a front side of the helmet body for transmitting at least one signal;
a first receiving unit disposed on the front side of the helmet body for receiving a first reflection signal reflected from an input object contacting the signal;
a second receiving unit disposed on the front side of the helmet body for receiving a second reflection signal reflected from the input object contacting the signal;
a third receiving unit disposed on the front side of the helmet body for receiving a third reflection signal reflected from the input object contacting the signal; and
a processing unit connected to the transmission unit and the first, second and third receiving units and the human-machine interface unit, whereby according to the sequence in which the first, second and third receiving units respectively receive the first, second and third reflection signals, the processing unit judges and identifies the position and/or motion of the input object and generates a gesture signal to the human-machine interface unit in accordance with the motion of the input object for interacting with the user interface.

9. The helmet as claimed in claim 8, wherein the second and third receiving units are positioned on the same level and left and right arranged and the first receiving unit is disposed on upper side or lower side of the second receiving unit or the third receiving unit.

10. The helmet as claimed in claim 9, wherein the signal is ultrasonic signal and the first, second and third reflection signals are ultrasonic reflection signals.

11. The helmet as claimed in claim 10, wherein the transmission unit is an ultrasonic transmitter and the receiving units are ultrasonic receivers.

12. The helmet as claimed in claim 8, wherein the input object contacts the signal in different times, whereby the first, second and third reflection signals have a time difference.

13. The helmet as claimed in claim 8, wherein the touchless user interface is a projected image containing multiple data.

14. The helmet as claimed in claim 8, wherein the human-machine interface unit is a projector.

15. The helmet as claimed in claim 14, wherein the helmet body has a visor disposed on the front side of the helmet body, the human-machine interface unit serving to project the user interface onto a predetermined position of the visor.

16. The helmet as claimed in claim 8, wherein the human-machine interface unit is head-up display for showing the user interface.

17. The helmet as claimed in claim 8, wherein the input object is a part of a user's body.
